(19) United States
(12) Patent Application Publication
(10) Pub. No.: US 2013/0235043 A1
(43) Pub. Date: Sep. 12, 2013

(54) Systems and Methods for Creating, Displaying, and Using Hierarchical Objects with Rigid Bodies

(71) Applicant: Eric J. Mueller, Fremont, CA (US)

(72) Inventor: Eric J. Mueller, Fremont, CA (US)

(73) Assignee: Adobe Systems Incorporated, San Jose, CA (US)

(21) Appl. No.: 12/197,746

(22) Filed: Aug. 25, 2008

(51) Int. Cl. G06T 13/00

(52) U.S. Cl. 345/473

(57) ABSTRACT

Methods involving the creation and use of rigid bodies with hierarchical objects are disclosed. For example, certain embodiments facilitate the creation, display, and/or editing of a rigid body of a hierarchical object. One embodiment displays a hierarchical object including a rigid body and allows inverse kinematics-based movement of the hierarchical object to control movement of the rigid body. For example, the position and/or rotation of a rigid body may be determined based on a bone having its base within the rigid body. As the bone is moved, the rigid body may move accordingly, for example by preserving a relationship between the rigid body and the bone.

### FIELD

Embodiments relate generally to the field of computing and specifically to computing applications used to create, control, and otherwise display objects.

### BACKGROUND

Media often involves the display of animated or moving objects. For example, a media object may consist of a series of frames played one after another by a media player. The sequential playing of the frames gives the appearance of objects within the frames moving over time. Development of such media can involve painstakingly creating each object in each frame independently. For example, animating a car moving down a street may involve redrawing the street and the car in a different position on the street in each of a series of multiple frames. Certain techniques exist to help developers simplify this otherwise painstaking and repetitive process. Some development tools allow a developer to reuse elements of a previous frame in a subsequent frame. For example, a developer may need to draw the street and the car only once to create the frames of the previous example. After drawing the street and the car for a first frame, the developer can save these objects in a first frame and then use them as a basis for created subsequent frames. A development tool may, for example, allow the developer to simply reposition the car object and save the second frame, reposition the car again and save the third frame, etc. Another technique that can simplify the process of creating animation involves extrapolating between frames created by a developer. In the previous example, a developer may create a first frame with the car at one end of a street and a second frame with the car at a second end of the street. The development tool can use the first and second frames as end points to create additional frames for inclusion in the play sequence of frames. For example, the positions of the car in the end frames can be used to determine several intermediate positions of the car on the street for intermediate frames.

In spite of these and other powerful features, present authoring and media environments could improve with respect to facilitating the movement of more complicated objects. In particular, moving objects that have multiple, interrelated parts continue to present various challenges. One example, is the complexity involved in animating a person or figure waving his or her hand or picking up an object on the ground. The more complex the figure (i.e., the more parts it has), the more difficult this task is for the developer. In many cases, the developer will be required to redraw (or reposition) each component of the object, e.g., the hand, the forearm, the upper arm, the shoulder, the head, etc.

The movement of multi-part and other complicated objects has been facilitated by defining an object as a “hierarchical object.” A “hierarchical object” is any object having at least some components to which a parent-child order has been ascribed (i.e., a first component is the parent of a second component, which is the parent of a third component, etc.). Just as a human figure/body is comprised of a plurality of bones, each bone being interconnected, and having a relationship with the adjacent bones, a hierarchical object can be considered to comprise a plurality of components that are also called “bones.” In one aspect a bone may be visualized as a straight line, or alternatively the bone may be visualized or displayed as a shape. Each of these bones has a base point and a tip point, approximately at each end of the bone, respectively. For example, where a first bone is the parent of a second bone, the tip of the first bone may be “attached” to the base of the second bone. This “attachment” can be used by a development tool to coordinate movement of the object, i.e., when one bone moves the other bone will move to preserve the attachment.

In addition to bones, hierarchical objects may also comprise linked components that are linked (with respect to movement) to the bones of the hierarchy. For example, an outer shape or mesh may be defined based on the position of one or more of the bones. As a specific example, an outer shape may be drawn by a developer and include various control points on the shape. When a bone is moved, any control points associated with the moved bone will cause the shape to move and/or deform. In the case of the person figure example described above, some development tools have allowed a developer to draw, for example, outline shapes of a hand, forearm, upper arm, shoulder, and the rest of the desired display components of a figure. The developer could then draw and associate a hierarchy of bones with these display components, so that movement of the hand outline shape causes the associated bone hierarchy to move, which then causes the other outline shapes to also move. For example, a single action by a developer moving the hand outline to a new position could automatically result in the repositioning of many (or all) of the other outlined components of the figure object, e.g., the forearm, upper arm, shoulder, hand, etc.

The use of hierarchical objects has been facilitated and/or enhanced with the use of kinematics techniques. For example, inverse kinematics have been used to reposition the bones of a hierarchical object based on a single movement created by a developer. Some development tools implement the kinematics techniques as algorithms executed behind the scenes, i.e., without direct user input or knowledge. Despite the advantages and benefits of using hierarchical object and kinematics techniques in the context of animating objects, many aspects of animation in computer-based media development continue to require significant user interaction.

### SUMMARY

Methods for control of the movement of displayed objects are provided, including objects that comprise rigid bodies. Rigid bodies are objects that provide display attributes that do not deform as the rigid body moves or rotates. For example, a rigid body may include a square perimeter that is constant in shape and size as the rigid body is repositioned and rotated. Control of the movement of an object may be facilitated using inverse kinematics procedures that allow complicated movements to be specified in simple ways. For example, an inverse kinematics procedure may move some or all of the many components of a hierarchical object based on a simple instruction to move a single part of the hierarchical object to another location. For example, a movement of a hierarchical object can be based on the identification of an end effector on the hierarchical object and an identification of a target location on the canvas area. An “end effector” is any point or part of an object that a developer intends to move or use to control movement. A “target location” is any point or other location to which the developer intends to move the end effector. In other words, specifying an end effector and a target location defines an intended movement, i.e., move that end effector to that target location. Because the positions of other components of a hierarchical object may be linked to or otherwise associated with the position of the end effector, those components of the hierarchical object may move as a result of an end effector being positioned at or nearer to the target location. In other words, by specifying an intended movement of one point or part of an object, a movement of the entire object may be specified, including movement of the individual components that comprise the object.

Thus, the movement of a hierarchical object may be controlled easily by a developer specifying a movement by identifying a target location to which an end effector should move. In a hierarchical object representing a person, for example, a developer, user, or application may select a point on the figure's finger as an end effector and a position directly out in front of the figure (on the canvas) to move the finger. The method may cause the finger to move to the position and determine corresponding movements for other components of the figure object, including movement of the figure's arm (e.g., extending towards the target location) and/or movement of the entire figure towards the end effector. These movements may be determined by calculating appropriate rotational and translational movements of components of the object that position the end effector nearer to the target location, e.g., as close as possible given any constraints placed on these movements.

In one embodiment, a computer implemented method comprises outputting a canvas area comprising a hierarchical object including a plurality of bones and a rigid body. A base of a bone of the plurality of bones is positioned within a perimeter of the rigid body and a relationship between the bone and the rigid body is maintained so that movement of the bone results in any movement of the rigid body necessary to maintain the relationship. The method further comprises receiving an identification of a movement for the hierarchical object. The identification of the movement may comprise an identification of an end effector on the hierarchical object and an identification of a target location, the target location identifying an intended movement of the end effector from an initial location on the canvas area to another location on the canvas area nearer to the target location. The method may further comprise moving the hierarchical object to position the end effector nearer to the target location using an inverse kinematics procedure. This movement of the hierarchical object may comprise movement of at least the bone and the rigid body, where the rigid body moves to maintain the relationship between the bone and the rigid body.

In other embodiments, a computer-readable medium (such as, for example, random access memory or a computer disk) comprises code for carrying out the methods described herein.

These illustrative embodiments are mentioned not to limit or define the invention, but to provide examples to aid understanding thereof Illustrative embodiments are discussed in the Detailed Description, and further description of the disclosure is provided there. Advantages offered by various embodiments of this disclosure may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIG. 1 is a system diagram illustrating a media content authoring environment and an exemplary runtime environment according to certain embodiments;

FIGS. 2a-f provide an example of creating, displaying, and changing a hierarchical object including rigid bodies, according to certain embodiments;

FIG. 3 is a flow chart illustrating a method of displaying a hierarchical object with a rigid body, according to certain embodiments; and

FIG. 4 is a flow chart illustrating a method of displaying a hierarchical object with a rigid body using a simulated bone, according to certain embodiments.

### DETAILED DESCRIPTION OF EXEMPLARY EMBODIMENTS

Methods involving the creation and use of rigid bodies with hierarchical objects are disclosed. For example, certain embodiments facilitate the creation, display, and/or editing of a rigid body of a hierarchical object. One embodiment displays a hierarchical object including a rigid body and allows inverse kinematics-based movement of the hierarchical object to control movement of the rigid body. For example, the position and/or rotation of a rigid body may be determined based on a bone having its base within the rigid body. As the bone is moved, the rigid body may move accordingly, for example by preserving a relationship between the rigid body and the bone.

### Illustration of Development of a Hierarchical Object with Rigid Bodies

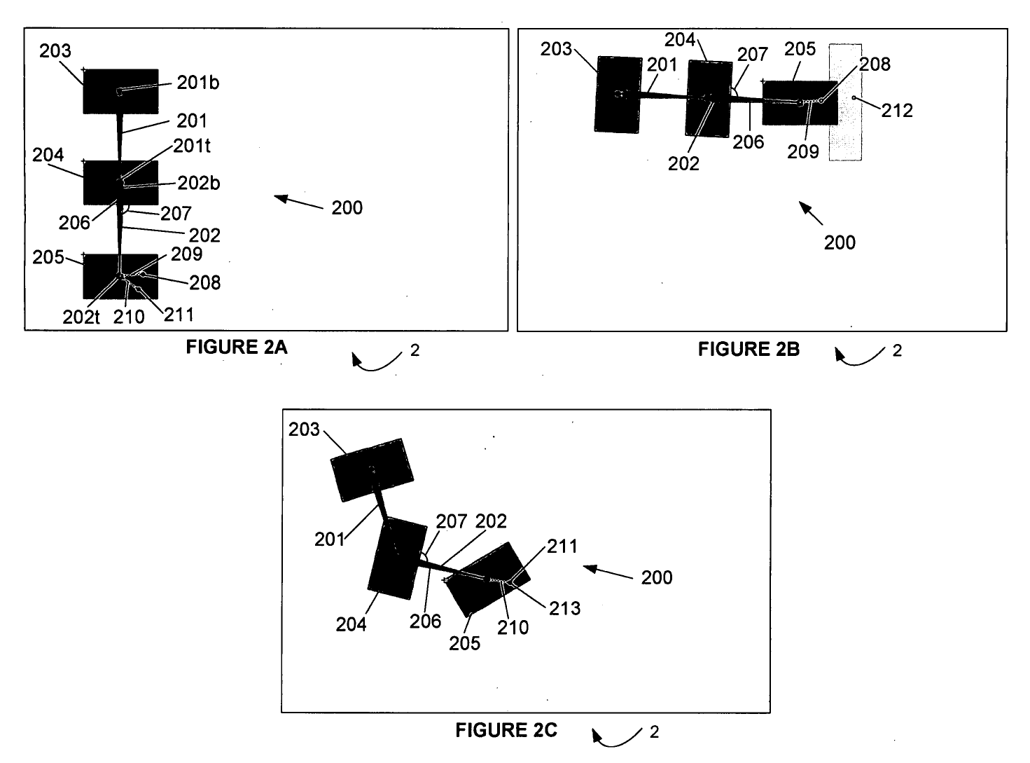

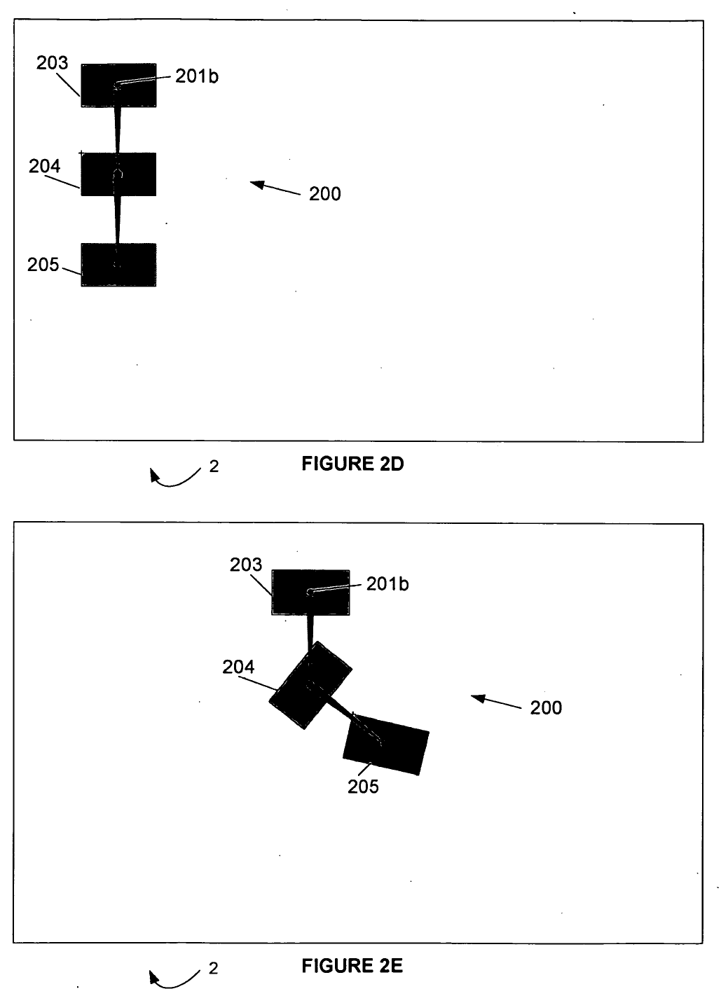

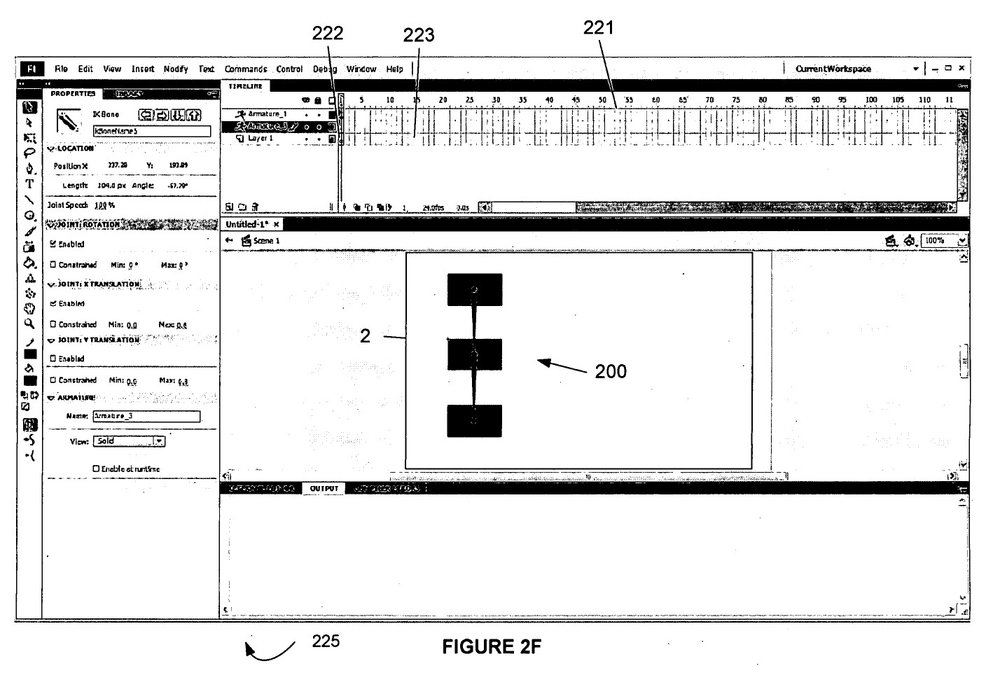

The following specific illustrative embodiment is provided to illustrate some of the applications, uses, and benefits of certain of the techniques described herein. Referring now to the drawings in which like numerals indicate like elements throughout the several figures, FIGS. 2a-f provide an example of a developer creating and changing a hierarchical object. The developer creates a hierarchical object 200 by creating bones 201, 202 and rigid bodies 203, 204, 205 on a canvas 2 displayed on an interface of a computer screen in a media content authoring environment. For example, the developer may have first placed a root bone 201 by identifying a location for a bone base 201b and a bone tip 201t and then placed another bone 202 to be a child of the root bone in the hierarchical object by identifying a location of a bone base 202b at (or near) the tip 201t of the root bone 201 and a bone tip 202t for the child bone. The developer may then create the rigid bodies 203, 204, 205, for example, by drawing perimeters for each of the rigid bodies 203, 204, 205. A rigid body may or may not be associated with the hierarchical object. Association with a hierarchical object may be assumed when a rigid body is drawn to include an area of the canvas 2 that includes one or more of the bone tips and/or bases. Alternatively, the association may be manually made by the developer, for example if a developer wishes to associate a rigid body that does not include a bone base or tip. In FIG. 2a, the first rigid body 203 is drawn to include the root bone base 201b. The second rigid body 204 is drawn to include the root bone tip 201t and the child bone base 202b. The third rigid body 205 is drawn to include the second bone tip 202t.

The terms “rigid body” and “rigid bodies” refer to any object that can be associated with a hierarchical object to move (rotate and/or translate) when one or more of the bones of the hierarchical object moves. A rigid body is “rigid” in the sense that its shape, i.e. its perimeter (or outer surface in the case of a three dimensional rigid body), does not change with the movement of the hierarchical object. For example, a circle remains a circle with the same diameter and a rectangle remains a rectangle with the same width and length as these objects rotate and/or translate based on the movement of the bones of the hierarchical object.

As shown in FIGS. 2a and 2b, the hierarchical object can be moved by the developer. In this case, the developer selects an end effector location 208 on the third rigid body 205 shown in FIG. 2a. For example, the developer may position a mouse cursor in that location and press the mouse button. The developer may then select a target location. In this case, the developer selects a target location 208 as shown in FIG. 2b. For example, the developer may move the mouse cursor with the mouse button still depressed from the selection of an end effector and release the mouse button when the mouse cursor is in a desired target location.

The media content development environment receives these end effector and target location selections and repositions the components of the hierarchical object. In this case, the bones 201 and 202 are rotated using inverse kinematics procedures that attempt to position the end effector 208 nearer to the target location 212. Here, the root bone 201 is fixed and its base 201b does not translate on the canvas 2. Thus, the end effector 208 is not positioned at the target location 212. However, the end effector 209 is positioned as close to the target location 212 as is possible given the no translation constraint.

The positions of the rigid bodies 203, 204, 205 are determined based on the changed positions of the bones 201, 202. In this case, the movement of the rigid bodies is tied to a bone having its base within the rigid body. Thus, the position of the first rigid body 203 is determined to maintain the rigid body's relationship to root bone base 201b (e.g., same distance from each side of the rectangle). Similarly, the rotation of the first rigid body 203 is determined based on the rotation of the root bone 201. For example, an angle between an axis of the root bone 201 and an axis of the first rigid body 203 may be maintained. The position of the second rigid body 204 is determined to maintain the rigid body's relationship to the child bone base 202b. As with the first rigid body 203, the rotation of the second rigid body 204 is determined based on the rotation of a bone having its base within the body, in this case the child bone 202. For example, an angle between an axis of the child bone 202 and an element of the rigid body 202, in this case, a side of the rectangle, is maintained. Thus, the angle 207 does not change as the hierarchical object is moved.

The position of the third rigid body 205 is determined in a similar manner. However, since the third rigid body 205 does not have a bone base within it in this example, the position of the third rigid body 205 is determined by defining a simulated bone 209 extending from the tip of the child bone 202 to the position of the end effector 208. The base of this simulated bone 209 is used to determine a position of the third rigid body 205 in FIG. 2b. The rotation of this simulated bone 209 is used to determine a rotation of the third rigid body 205. For example, a relationship, such as an angle between axes, can be maintained to determine a rotation for the rigid body 205.

FIGS. 2a and 2c provide another exemplary movement of the hierarchical object 200. In this example, the developer selects the end effector location 211 shown in FIG. 2a and then selects the target location 213 shown in FIG. 2c. In this case, the end effector 211 is repositioned at the target location 213. This positioning is accomplished using an inverse kinematics procedure on the hierarchical object 211. In this case, the set of bones includes the root bone 201, the child bone 202, and a simulated bone 210. The use of a simulated bone is not necessary, however, and other techniques for determining the movement may be used. As with the previous example, positions/rotations for each of the bones 201, 202, 210 are determined and then used to determine appropriate positions/rotations for the associated rigid bodies 203, 204, 205. Specifically, the root bone 201 is used to position the first rigid body 203, the child bone 202 is used to position the second rigid body 204, and the simulated bone 210 is used to position the third rigid body 205.

FIGS. 2d-2e illustrate how the hierarchical object 200 including the associated rigid bodies 203, 204, 205 can be moved in the case where translation of the root bone base 201b is not constrained in the horizontal direction. Additional techniques for allowing and using translation of hierarchical object components are disclosed in U.S. Patent Application entitled “SYSTEMS AND METHODS FOR MOVING HIERARCHICAL OBJECTS,” filed concurrently herewith, and incorporated herein in its entirety by this reference. The positions (i.e. locations and/or orientations) of the rigid bodies can be determined based on the positions of the bones, as described above and herein.

Generally, a developer may use a hierarchical object to define an animation, for example by taking snapshots of the hierarchical object in various positions and then using the multiple snapshots to define animated movement. For example, the developer could take a snapshot of the object in a first position as shown in FIG. 2a and associate it with an instance on a timeline 221 of the media content authoring environment, shown in FIG. 2f. The developer may then move the hierarchical shape to a new position as shown in FIG. 2c and associate the newly positioned shape with a later point 223 along the timeline 221. When the timeline is later used to create media content, the application may extrapolate positions for the starting and ending locations associated with each of the timeline snapshot points 222, 223. For more precise control of the movement, a developer can simply place additional snapshots in the timeline or otherwise reduce the time between snapshots, among other things.

FIGS. 2a-f also illustrate how the movement of a hierarchical object 200 can be controlled. For example, control may be based on identification of an end effector and a target point or location. A developer might use a mouse device to specify an end effector and a target location. The developer clicks the mouse when the mouse cursor is located on a specified end effector location on the hierarchical object 200. The developer continues to hold the mouse button down as he moves the mouse cursor across the canvas 2 to a final target location, where the mouse button is released. At the conclusion of this mouse movement, the hierarchical object 200, will have moved according to the target location, end effector, and other characteristics of the hierarchical object. The movements illustrated in FIGS. 2a-c may have been controlled in this manner, for example.

Moving the mouse cursor across the canvas 2 may have generated a stream of target locations that could be used to iteratively move the hierarchical object, allowing the developer to see the changes to the hierarchical object 200 as he drags the mouse. For each new target location of the stream of target locations, an appropriate movement of the hierarchical object 200 is determined and displayed. The movement may comprise either a rotation, e.g., a rotation of a bone determined by an inverse kinematics procedure, a translation, or both a rotation and a translation of one or more bones 201, 202 of the hierarchical object 200.

The amount of rotation and or translation may be constrained in various ways, e.g., with angular limitations, positional limitations, limitations with respect to only translating in a certain direction, etc. In certain cases, these constraints may prevent the end effector from being moved to the target location, however, rotational and translational movements may be determined and displayed to position the end effector nearer to the target location. Thus, positioning the end effector nearer to the target location may comprise positioning it as close to the target location as possible and in some cases positioning it at the target location.

These illustrative examples are given to introduce the reader to the general subject matter discussed herein and are not intended to limit the scope of the disclosed concepts. The following sections describe various additional embodiments and examples of methods and systems for monitoring content consumption.

### Illustrative Authoring and Runtime Environments

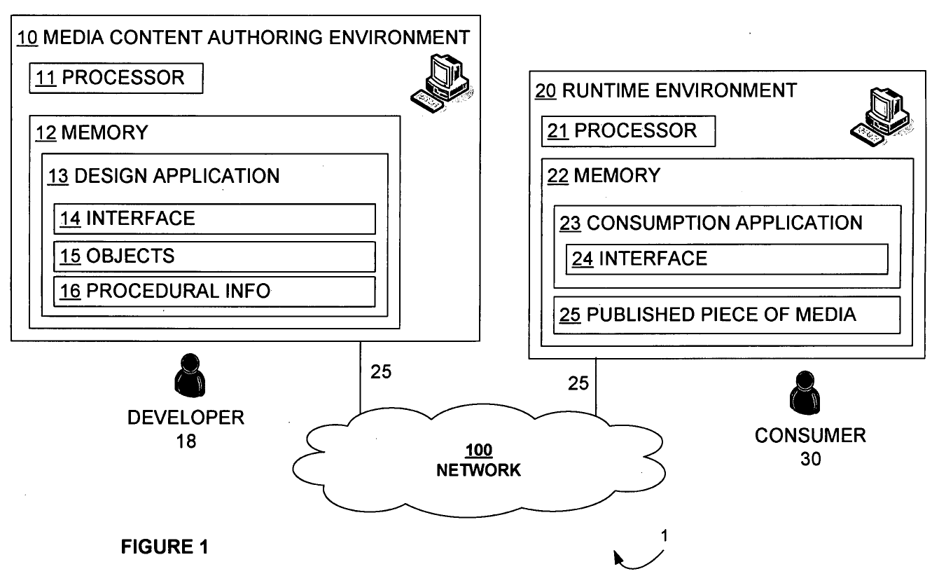

FIG. 1 is a system diagram illustrating a media content authoring environment 10 and an exemplary runtime environment 20 according to certain embodiments. Other embodiments may be utilized. The system 1 shown in FIG. 1 comprises a media content authoring environment 10, which may, for example, include a computing device that comprises a processor 11 and a memory 12. A developer 18 uses the media content authoring environment 10 to author media content. The memory 12 may comprise a design application 13 with an interface 14 that the developer 18 uses for such authoring. The interface 14 may provide a graphical design area or canvas area upon which the developer 18 may place, position, and otherwise define objects that will be a part of a piece of media that is being developed. Information about such objects may be stored in memory 12.

The design application 13 may allow the developer 18 to create and use hierarchical objects, for example, by allowing the developer 18 to position components on a graphical design area and create and revise relationships between components of a hierarchical object.

The design application 13 may further allow the developer 18 to perform procedures on objects of the piece of media being developed, including performing kinematics procedures. Thus, a developer 18 may specify a two bone hierarchical object and then specify end-effector and target locations for a kinematics-based movement. The design application 12 comprises procedural information 16 for carrying out these kinematics and other procedures within the design application 13, for example, by displaying the movement on a graphical design area.

Once the developer is ready to publish a piece of media to a runtime environment, the design application 13 generates a piece of media 25. The piece of media 25 may be used by another application on the developer's computing device or sent to another location, for example, through a network 100 to a runtime environment 20. The runtime environment may also include a processor 21 and a memory 22. The memory 22 will generally include a consumption application 23 that provides an interface 24 for viewing or otherwise consuming pieces of media. The piece of media 25 may be stored in memory 22 and viewed or otherwise consumed by a consumer 30 using the interface 24 of the consumption application 23.

### Illustrative Method of Displaying a Hierarchical Object with a Rigid Body

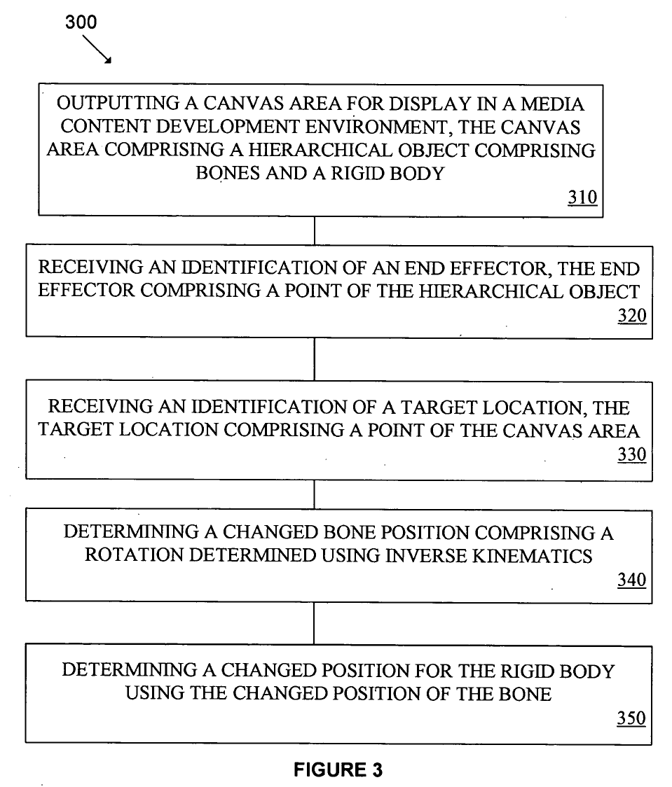

FIG. 3 is a flow chart illustrating a method of displaying a hierarchical object with a rigid body, according to certain embodiments. For purposes of illustration only, the elements of this method 300 may be described with reference to the system depicted in FIG. 1. A variety of other implementations are also possible.

The method 300 may be computer-implemented. The method 300 comprises outputting a canvas area for display in a media content development environment, the canvas area comprising a hierarchical object, as shown in block 310. This may involve receiving information about component objects and one or more relationships between the component objects of the hierarchical object. These component objects may, as examples, comprise one or more bones, shapes, and/or rigid bodies. For example, the hierarchical object may comprise bones and a rigid body with a base of a bone positioned within the rigid body. The information about component objects may, as examples, comprise information connecting bones to one another in a hierarchical scheme and that link or otherwise associate one or more rigid bodies with one or more of the bones. The information may comprise constraint information (e.g., angular limits, translation limits), and/or any other relevant information. A constraint may limit the translation and/or rotation of a bone of a hierarchical object, among other things. In certain embodiments, the position of a rigid body is defined by a matrix, for example, a set of numbers that uniquely identifies the position (location and/or orientation) of a rigid body on a canvas.

Receiving and/or displaying a hierarchical object for a piece of media in a canvas area of a media content authoring environment can involve a system such as the system illustrated in FIG. 1. As one example, the media content authoring environment 10 could receive in the interface 14 of a design application 13 one or more inputs from a developer 18 specifying the location of two related bones: a parent bone connected to a child bone. The interface 14 may also receive, for example, a constraint from the developer 18 specifying that the angle between the bones shall not be less than 45 degrees. As another example, the developer 18 may further specify that a rigid body will be positioned surrounding the intersection of the two bones by drawing a shape around that intersection.

Referring again to FIG. 3, the method 300 further comprises receiving an identification of an end effector as a location or other point of the hierarchical object, as shown in block 320. For example, a developer may have selected a point on a bone or a point on a rigid body of the hierarchical object by positioning a mouse cursor on a desired bone or rigid body and clicking the mouse button.

Similarly, the method 300 further comprises receiving an identification of a target location, the target location comprising a location or other point of the canvas area, as shown in block 330. The target location may be selected using a selection device such as a mouse. The identifications of the end effector and/or target location can be specified by a script, a developer, or in any other manner.

The method 300 further comprises determining a changed position of the bone comprising a rotation determined using an inverse kinematics procedure, as shown in block 340. This will generally involve identifying an amount of rotation of the bone about the base of the bone. An inverse kinematics procedure may attempt to position the end effector nearer to and/or at the target location by, for example, adjusting the angles between bones. Thus, the changed position of the bone may comprise an amount of movement of the bone based on rotation of a parent bone, rotation of the bone itself, and/or translational movement of the hierarchical object.

The method 300 further comprises determining a changed position for the rigid body using the changed position of the bone, as shown in block 340. For example, determining the changed position of the rigid body may be based on an amount of movement of the bone and/or maintaining one or more relationships between the bone and the rigid body. One exemplary relationship is an angle between an axis (or other part) of the rigid body and an axis (or other part) of the bone. Thus, the changed position of the rigid body may comprise a rotation of the rigid body and/or a translational movement of the rigid body.

The method 300 may comprise repositioning the hierarchical object, for example, in the context of a developer creating an animation of the shape by repositioning the hierarchical object in various positions for an animation. Such an animation may comprise a time period over which the repositioning will be displayed by the piece of media content. The animation may comprise, for example, a first snapshot associated with a first time instance, the first snapshot comprising the position of the shape prior to repositioning; and a second snapshot associated with another time instance, the second snapshot comprising the position of the shape after repositioning.

The method 300 may comprise receiving a stream of target locations based on a moving position of a cursor on the canvas area. For each target location of the stream of target locations, a movement of the bone and a movement of the rigid body are determined and displayed.

### Illustrative Method of Using a Simulated Bone

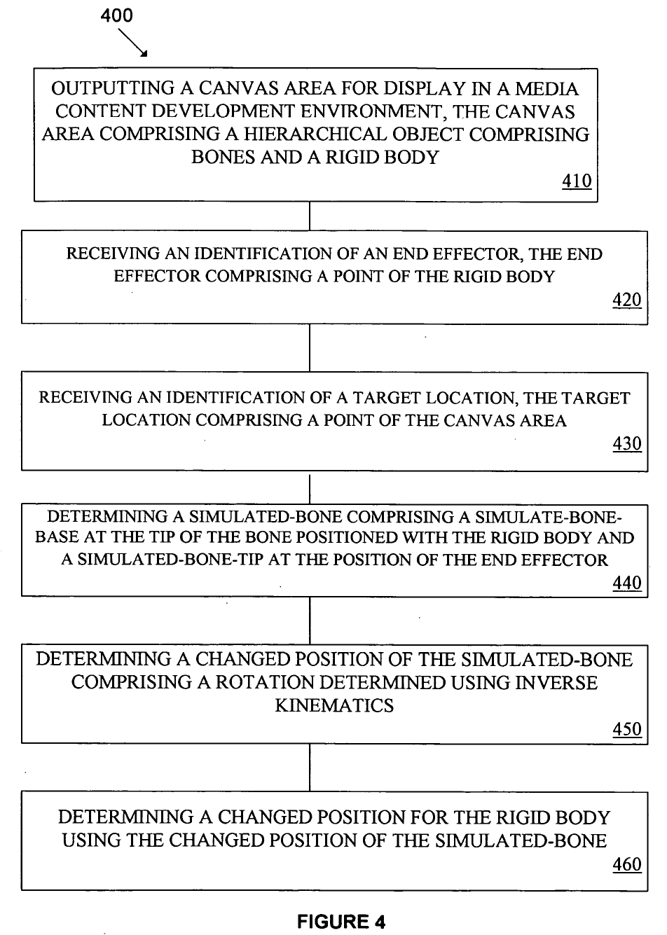

FIG. 4 is a flow chart illustrating a method of displaying a hierarchical object with a rigid body using a simulated bone, according to certain embodiments. For purposes of illustration only, the elements of this method 400 may be described with reference to the system depicted in FIG. 1. A variety of other implementations are also possible.

The method 400 may be computer-implemented such as in the media content authoring environment 10 of FIG. 1. The method 400 comprises outputting a canvas area for display in a media content development environment, the canvas area comprising a hierarchical object of bones and a rigid body, as shown in block 410. This may involve receiving information about component objects and one or more relationships between the component objects of the hierarchical object. These component objects may, as examples, comprise one or more bones, shapes, and/or rigid bodies. In certain embodiments, a base of a bone of the plurality of bones is positioned external to the rigid body and a tip of the bone is positioned within the rigid body.

The method 400 further comprises receiving an identification of an end effector as a location or other point on a rigid body of the hierarchical object, as shown in block 420. For example, a developer may have selected a point on a rigid body of the hierarchical object by positioning a mouse cursor on a desired location on a rigid body and clicking the mouse button.

Similarly, the method 400 further comprises receiving an identification of a target location, the target location comprising a location or other point of the canvas area, as shown in block 430. The target location may be selected using a selection device such as a mouse. The identifications of the end effector and/or target location can be specified by a script, a user, or otherwise.

The method 400 further comprises determining a simulated-bone comprising a simulated-bone-base at the tip of a bone positioned within the rigid body and a simulated-bone-tip at the position of the end effector, as shown in block 440. The simulated bone may be considered a child bone of the bone to which it attaches or is otherwise associated.

The method 400 further comprises determining a changed position of the simulated-bone comprising a rotation determined using an inverse kinematics procedure, as shown in block 450. The inverse kinematics procedure may identify an amount of rotation of the simulated-bone about the simulated-bone-base. In certain embodiments, the inverse kinematics procedures are applied to control movement of the hierarchical object in the usual way with the exception that the simulated bone is also treated as a bone of the hierarchical object. Thus, an inverse kinematics procedure may attempt to position the tip of the simulated bone nearer to or at the target location. Note that, in this case, the tip of the simulated bone is the location of the selected end effector within the rigid body.

The method 400 further comprises determining a changed position for the rigid body using the changed position of the simulated-bone. This may involve determining a changed position and/or rotation for the rigid body. For example, if the rigid body is associated with a matrix of six numbers identifying its location (e.g., three for its position and three for its rotation), one or more of these numbers may be changed to reposition the rigid body, for example, to preserve a relationship (axis to axis angle, etc.) between the rigid body and one or more associated bones.

### General

Certain embodiments relate to inverse kinematics. These are merely illustrative. In short, the techniques and the other features described herein have uses in a variety of contexts, not to be limited by the specific illustrations provided herein. It should also be noted that embodiments may comprise systems having different architecture and information flows than those shown in the Figures. The systems shown are merely illustrative and are not intended to indicate that any system component, feature, or information flow is essential or necessary to any embodiment or limiting the scope of the present disclosure. The foregoing description of the embodiments has been presented only for the purpose of illustration and description and is not intended to be exhaustive or to limit the disclosure to the precise forms disclosed. Numerous modifications and adaptations are apparent to those skilled in the art without departing from the spirit and scope of the disclosure.

In addition, with respect to the computer implementations depicted in the Figures and described herein, certain details, known to those of skill in the art have been omitted. For example, software tools and applications that execute on each of the devices and functions performed thereon are shown in FIG. 1 as functional or storage components on the respective devices. As is known to one of skill in the art, such applications may be resident in any suitable computer-readable medium and execute on any suitable processor. For example, the devices at environments 10, 20 each may comprise a computer-readable medium such as a random access memory (RAM), coupled to a processor that executes computer-executable program instructions stored in memory. Such processors may comprise a microprocessor, an ASIC, a state machine, or other processor, and can be any of a number of computer processors. Such processors comprise, or may be in communication with a computer-readable medium which stores instructions that, when executed by the processor, cause the processor to perform the steps described herein.

A computer-readable medium may comprise, but is not limited to, an electronic, optical, magnetic, or other storage or transmission device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. A computer-readable medium may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

While the network 100 shown in FIG. 1 may comprise the Internet, in other embodiments, other networks, such as an intranet, or no network may be used. Moreover, methods may operate within a single device. Devices can be connected to a network 100 as shown. Alternative configurations are of course possible. The devices may also comprise a number of external or internal devices such as a mouse, a CD-ROM, DVD, a keyboard, a display, or other input or output devices. Examples of devices are personal computers, digital assistants, personal digital assistants, cellular phones, mobile phones, smart phones, pagers, digital tablets, laptop computers, Internet appliances, other processor-based devices, and television viewing devices. In general, a device may be any type of processor-based platform that operates on any operating system capable of supporting one or more client applications or media content consuming programs.

It should also be recognized that kinematics procedures (both forward and inverse) can be used to facilitate the movement of a hierarchical object (usually by adjusting angles between bones) and provide benefits in a variety of circumstances, including in the context of facilitating the animation of hierarchical object-based elements in computer-based media. “Forward kinematics” refers to moving a parent bone to affect child bone(s) (i.e., affects go down the hierarchy), while “inverse kinematics” refers to moving a child bone to affect parent bone(s) (i.e., up the hierarchy). Inverse kinematics may be used to facilitate the simple control of movement of a hierarchy object (such as an entire arm or an entire person figure), by simply moving one component (such as a hand bone).

1. A computer-implemented method, comprising:
outputting a canvas area for display in a media content development environment, the canvas area comprising a hierarchical object, the hierarchical object comprising a plurality of bones and a rigid body;
receiving an identification of a movement for the hierarchical object, the identification of the movement comprising an identification of an end effector on the hierarchical object and an identification of a target location, the target location identifying an intended movement of the end effector from an initial location on the canvas area to another location on the canvas area nearer to the target location;
based on the identification of the end effector, creating, via a processor, a simulated-bone comprising a simulated-bone-base at a tip of a bone of the plurality of bones and the simulated-bone comprising a simulated-bone-tip at a position of the end effector; and
moving the hierarchical object to position the end effector nearer to the target location using an inverse kinematics procedure, movement of the hierarchical object comprising movement of at least the simulated-bone and the rigid body, wherein the rigid body moves to maintain a relationship between the simulated-bone and the rigid body.

2. The method of claim 1 further comprising creating an animation for a piece of media content, the animation comprising the movement of the rigid body.

3. The method of claim 2, wherein the animation comprises a time period over which the movement of the rigid body will be displayed by the piece of media content.

4. The method of claim 1, further comprising creating an animation for a piece of media content, the animation comprising:
a first snapshot associated with a point during a time period, the first snapshot comprising a position of the rigid body prior to the movement of the rigid body; and
a second snapshot associated with another point during the time period, the second snapshot comprising a changed position of the rigid body after the movement of the rigid body.

5. The method of claim 1, wherein the relationship comprises an angle between an axis of the rigid body and an axis of the simulated-bone.

6. The method of claim 1, wherein the relationship comprises a position of the simulated-bone-base relative to the perimeter of the rigid body.

7. The method of claim 1, wherein the movement of the simulated-bone comprises a rotation of the simulated-bone.

8. The method of claim 7, wherein the rotation of the simulated-bone causes the rigid body to rotate.

9. The method of claim 7, wherein the rotation of the simulated-bone causes the rigid body to translate.

10. The method of claim 1, wherein a position of the rigid body is defined by a matrix.

11. The method of claim 1, wherein the inverse kinematics procedure positions the end effector at the target location.

12. The method of claim 1, wherein a rotation is determined for each of the bones of the hierarchical structure that allow rotation.

13. The method of claim 1, further comprising:
receiving a stream of target locations based on a moving position of a cursor on the canvas area; and
for each target location of the stream of target locations, determining and displaying an additional movement of the rigid body.

14. The method of claim 1, wherein the end effector comprises a point on the rigid body.

15. The method of claim 1, wherein a constraint on the hierarchical object limits the rotation of the simulated-bone.

16. The method of claim 1, wherein a tip of the simulated-bone is positioned external to the rigid body.

17-19. (canceled)

20. A computer-implemented method, comprising:
outputting a canvas area for display in a media content development environment, the canvas area comprising a hierarchical object, the hierarchical object comprising: a plurality of bones and a rigid body, wherein a base and a tip of a bone of the plurality of bones are positioned within a perimeter of the rigid body;
receiving an identification of a movement for the hierarchical object, the identification of the movement comprising an identification of an end effector and an identification of a target location, the target location identifying an intended movement of the end effector from an initial location on the canvas area to another location on the canvas area nearer to the target location;
based on the identification of the end effector, creating, via a processor, a simulated-bone comprising a simulated-bone-base at the tip of the bone positioned within the rigid body and a simulated-bone-tip at a position of the end effector;
moving the hierarchical object to position the end effector nearer to the target location using an inverse kinematics procedure, movement of the hierarchical object comprising movement of at least the simulated bone and the rigid body, wherein the rigid body moves to maintain a relationship between the simulated bone and the rigid body.

21. The method of claim 20, wherein the relationship is an angle between an axis of the rigid body and an axis of the simulated-bone.

22. A system comprising:
instructions stored on a non-transitory computer readable medium;
a processor operable to execute the instructions that when executed by the processor cause the processor to:
provide an interface for displaying a canvas area comprising a hierarchical object in a media content authoring environment and for receiving an identification of an end effector and an identification of a target location, the end effector comprising a point of the hierarchical object, the target location comprising a point of the canvas area; and
based on the identification of the end effector, create a simulated-bone comprising a simulated-bone-base at a tip of a bone positioned within a rigid body and a simulated-bone-tip at a position of the end effector
move the hierarchical object to position the end effector nearer to the target location using an inverse kinematics procedure, movement of the hierarchical object comprising movement of at least the rigid body, wherein the rigid body moves to maintain a relationship between the simulated-bone and the rigid body.

23. A non-transitory computer-readable medium on which is encoded program code, the program code comprising:
program code for outputting a canvas area for display in a media content development environment, the canvas area comprising a hierarchical object, the hierarchical object comprising a plurality of bones and a rigid body;
program code for receiving an identification of a movement for the hierarchical object, the identification of the movement comprising an identification of an end effector on the hierarchical object and an identification of a target location, the target location identifying an intended movement of the end effector from an initial location on the canvas area to another location on the canvas area nearer to the target location;
program code for, based on the identification of the end effector, creating, via a processor, a simulated-bone comprising a simulated-bone-base at a tip of a bone of the plurality of bones and the simulated-bone comprises a simulated-bone-tip at a position of the end effector; and
program code for moving the hierarchical object to position the end effector nearer to the target location using an inverse kinematics procedure, movement of the hierarchical object comprising movement of at least the simulated-bone and the rigid body, wherein the rigid body moves to maintain a relationship between the simulated-bone and the rigid body.

24. (canceled)
